(19) United States
(12) Patent Application Publication
(10) Pub. No.: US 2007/0157174 A1
(43) Pub. Date: Jul. 5, 2007

(54) Debugger with on the fly script generation

(76) Inventors: Boris Gebhardt, Wiesloch (DE); Christoph Stoeck, Eppelheim (DE)

Correspondence Address: FISH & RICHARDSON, P.C., PO BOX 1022, MINNEAPOLIS, MN, 55440-1022, US

(21) Appl. No.: 11/322,887

(22) Filed: Dec. 30, 2005

(51) Int. Cl. G06F 9/44

(52) U.S. Cl. 717/124

(57) ABSTRACT

A debugging script and at least one trigger point and associating the at least one trigger point with the debugging script may be defined. Thereafter, the debugging script may be compiled on the fly. When a defined trigger point is identified in a section of code during run time of a debuggee, the debugger script may be executed to automatically debug the code. Related apparatuses, computer program products, and computer systems are also described.

### TECHNICAL FIELD

The subject matter described herein relates to a debugger with on the fly script editing and generation.

### BACKGROUND

Debugging of computer programs often involves repetitive operations. In an effort to automate certain aspects of debugging, debuggers have been presented which utilize scripts containing reusable patterns. While such scriptable debuggers reduce human involvement in a debugging process, conventional processes for editing and modifying such scripts can be burdensome and require off line script generation.

### SUMMARY

In one aspect, either an existing debugging script is reused (and/or edited) or a new debugging script is generated, while “generated” means herein created manually by a user or automatically by a computer program. The script may be edited in a stand-alone editor or an integrated editor during debugging. If the debugging script is edited, it may optionally be saved to a script repository. Thereafter, either at least one existing trigger point is reused (and/or edited) or at least one new trigger point is created. The trigger point(s) may be created and/or edited in a stand-alone editor or in an integrated editor during debugging. Optionally, the trigger point may be saved to a trigger point repository. Moreover, trigger points may be associated with debugging scripts and the combination of both may be saved likewise. Thereafter, the debugging script is compiled on the fly. The debugging script is later executed in response to an identification of a trigger point during run time of a debuggee to automatically debug code.

In an interrelated aspect, at least one trigger point (e.g. assertion) in a section of code to be debugged may be defined. The trigger points may be associated with a debugger script or a combination of a debugger script and additional trigger points. Thereafter, a debugger may be created and the debugger script (compiled on the fly, if necessary and) executed in response to an identification of the defined trigger points during run time of a debuggee to automatically debug associated code.

In another interrelated aspect, a trigger point in a section of code to be debugged may be identified. This trigger point is already associated or may subsequently be associated with a debugger script. This debugger script, or a portion thereof, may be displayed in an editor during run-time of the debugging so that modifications may be made to the script. Subsequently the script may be compiled on the fly and executed.

In some variations, at least one of the code and the debugger script is in Advanced Business Application Programming language. In addition, in some implementations, the trigger point may be pre-defined (it will also be appreciated that there may be a plurality of trigger points). The trigger point may be based on factors such as user-defined watchpoints, user-defined breakpoints, and the like. Alternatively, the trigger point may correspond to each line of code traversed by a debugger.

In a further interrelated aspect, a trigger point within a section of code to be debugged may be identified. Thereafter, a debugger script editor (which may include, for example, a wizard presenting a series of interrogatories) may be launched to enable a user to compile a debugger script on the fly in the script editor. Thereafter, the compiled debugger script may be executed to debug the code.

In yet another interrelated aspect, a debugging script may be defined. Thereafter, at least one trigger (e.g., assertion) may be defined for the debugging script. The debugging script can then be compiled on the fly so that the debugger script can be executed to debug code when a defined trigger is identified within a section of code to be debugged.

Computer program products, which may be embodied on computer readable-material, are also described. Such computer program products may include executable instructions that cause a computer system to conduct one or more of the method acts described herein.

Similarly, computer systems are also described that may include a processor and a memory coupled to the processor. The memory may encode one or more programs that cause the processor to perform one or more of the method acts described herein.

The subject matter described herein provides many advantages. For example, by using standard ABAP as script debugging language, a user may readily write a simple ABAP script that permits: statement tracing; branch or path coverage; an overview over all database accesses; tracing of overall memory consumption; user defined watchpoints; the ability to analyze the content of an internal table automatically (e.g., finding duplicate entries); and additionally by allowing the influence of the execution of the debuggee programmatically by changing variables or resetting the debugger execution pointer according certain conditions. Moreover, the debugger architecture described herein is arranged so that the execution of code during debugging takes place at the debugger side thereby limiting the risk of unintended side-effects. With such an arrangement, it can be ensured that the debuggee operates under debugger control in a same manner as it would operate without such control.

The details of one or more variations of the subject matter described herein are set forth in the accompanying drawings and the description below. Other features and advantages of the subject matter described herein will be apparent from the description and drawings, and from the claims.

### DESCRIPTION OF DRAWINGS

FIG. 1 is a process flow diagram illustrating a method of editing debugging scripts on the fly;

FIG. 2 is a process flow diagram illustrating a method interrelated to the method of FIG. 1 of generating debugging scripts on the fly; and

FIG. 3 is a diagram illustrating an overview of a debugging architecture.

### DETAILED DESCRIPTION

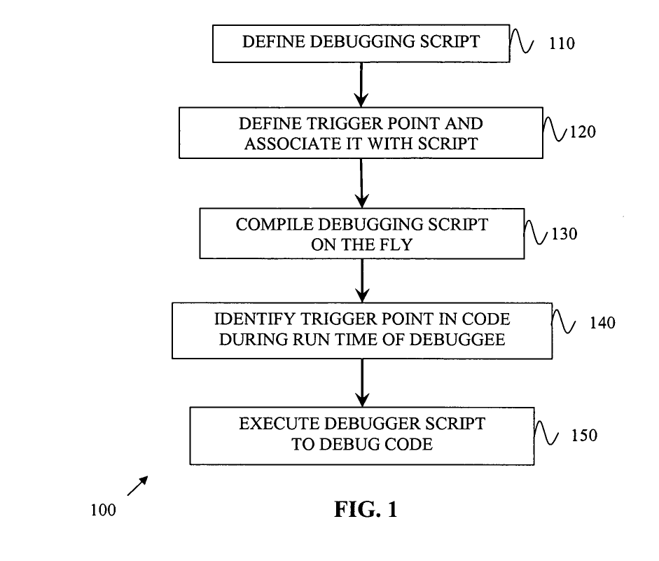

FIG. 1 is a process flow diagram of a method 100 in which, at 110, a debugging script is defined. This debugging script definition may comprise accessing a predefined debugging script, modifying a pre-existing debugging script in a stand-alone editor or an integrated editor during debugging, or generating a new debugging script in a stand-alone editor or an integrated editor during debugging. Optionally, the debugging script may be stored in a script repository. At 120, at least one trigger point is defined and associated with the debugging script. This trigger point definition may comprise accessing a predefined trigger point, modifying a pre-existing trigger point in a stand-alone editor or an integrated editor during debugging, or creating a new trigger point in a stand-alone editor or an integrated editor during debugging. Optionally, the trigger point may be stored in a trigger point repository. Thereafter, at 130, the debugging script is compiled on the fly. During run time of a debuggee, at 140, a defined trigger point is identified in a section of code. In response to this identification, at 150, the debugger script is executed to automatically debug the code.

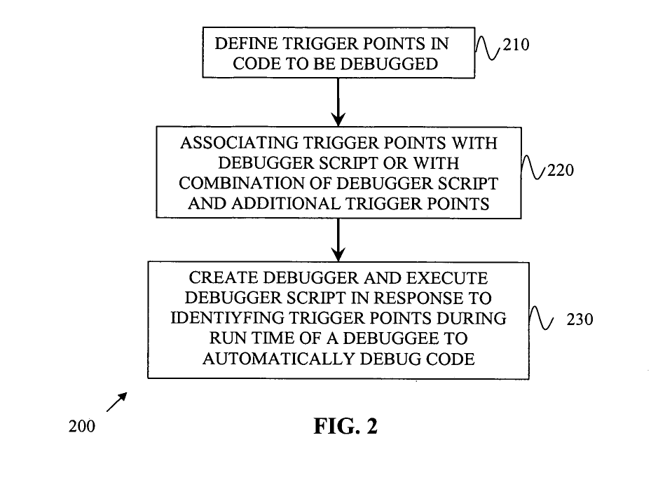

FIG. 2 is a process flow diagram of a method 200, interrelated to the method 100 of FIG. 1, in which, at 210, one or more trigger points in a section of code to be debugged are defined. Thereafter, at 220, the trigger points are associated with a debugger script or with a combination of debugger script and additional trigger points. A debugger may then be created, at 230, so that the debugger script can be executed in response to identifying the defined trigger points during run time of a debuggee to automatically debug the code.

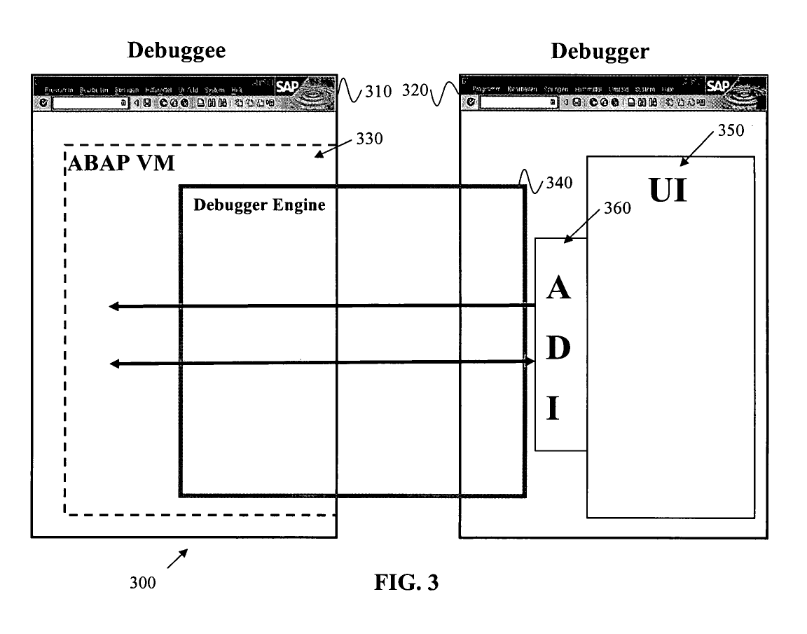

FIG. 3 illustrates an ABAP implementation of a debugger architecture 300 that enables debugging of a computer application written in ABAP (referred to as the debuggee 310) and/or using scripts written in ABAP by a debugger 320. The debugger architecture 300 is a multi-tiered architecture which allows debugger applications to run portably across platforms, virtual machine (VM) implementations, and Software Development Kits (SDK) versions. The debugger architecture 300 may optionally include three layered Application Program Interfaces (APIs) which include: ABAP VM Debug Interface 330 which defines debugging services a VM provides, ABAP Debugger Engine 340 which defines communications between debuggee 310 and debugger processes 320, and a ABAP Debug Interface 360 (ADI) which defines a high level ABAP language interface for a debugger session 320 to communicate with a debuggee session 310. The ADI 360 is a functional interface summing up methods, like “doDebugStep()”, “getVariableValue()” or “getCurrentStack()”. A user interface 350 sits on top of the debugger engine 340 to provide a graphical representation of both, standard interactive debugging features, like source code display of the debuggee 310 as well as an editor for debugging scripts to facilitate automated debugging. With this arrangement, the debugger 320 is initiated in a separate session which results in the debuggee 310 becoming inactive.

A debugger script may be edited and executed online without saving it in a database using an editor residing in the user interface 350. The user interface 350 also provides other standard operations such as displaying code as it is being debugged and additionally allows for the definition of trigger points within the code.

The following is an example of a sample debugger script which runs on the debugger side 320 and can communication and control the debuggee 310. While the debuggers script described below is a normal ABAP class, it will be appreciated that a wide variety of programming languages may be utilized. In one variation, persistent debugger scripts comprising standard ABAP programs (to be precise Subroutine pools) which can be edited in se38 (e.g., name of the programs RSTPDA_SCRIPT. . . ) may be utilized.

A debugger script may consist of two major parts:

The script attributes which are stored in a header section of the script:

```
    *<SCRIPT:HEADER>
*
    *<WP_REACHED>X</WP_REACHED>
    *</SCRIPT:HEADER>
```

The local class which contains the script code:

class lcl_debugger_script definition
inheriting from cl_tpda_script_class_super .

Here, the local script class inherits from CL_TPDA_SCRIPT_CLASS_SUPER. The class name should be LCL_DEBUGGER_SCRIPT. Another name may be selected provided that such name is provided in the attribute SCRIPT_CLASS.

The local script class may inherit three public scripting methods from super class CL_TPDA_SCRIPT_CLASS_SUPER:

| public section. | | |
|---|---|---|
| methods: | init | redefinition, |
| | script | redefinition, |
| | end | redefinition. |

With this variation, only method script is abstract and needs to be redefined. All other methods may optionally be redefined.

During debugger scripting the init method of the script class is first called. Here normally the initialization or perhaps some user interaction is located. The script method is executed whenever the defined trigger points are reached. A method end is executed when the user stops the scripting and before the traces are written on the database. At this point, for example, data may be aggregated before it is written to a file.

The trigger points define when method SCRIPT of the local debugger script class should run. Trigger points may be defined so that they execute immediately (i.e., run now and only once) or they may be associated with a debugger event. For example, a trigger point may be defined after each single step in the debugger so that the script framework executes debugger single steps (utilizing the respective method of the ADI) in an endless loop and calls the SCRIPT method after each single step.

A trigger point may also be defined to occur when a breakpoint is reached within the code being debugged. Such breakpoints may be created by a user manually and may cause the script framework to execute utilizing the respective method of the ADI in an endless loop and run the script methods whenever the trigger breakpoint is reached. Breakpoints may be defined by ABAP statement breakpoints, Method, Function, Form; a point at which a new program is reached; a point at which a new stack level is reached and the like.

Trigger points may also be defined to occur when a watchpoint in the code being debugged is reached. Watchpoints may also be user defined criteria relating to values of local variables and the like.

In some variations, the script super class provides the following services including “stop debugger scripting” (which stops the application and optionally stops the scripting):

```
    if me->find_duplicate_entries( l_itab ) = abap_true.
  me->break( ).
endif.
```

Another service is “write data to a file”:

Instance trace (interface IF_TPDA_SCRIPT_TRACE_WRITE) provides methods to write trace entries to a file on a local application server:

| | |
|---|---|
| ADD_SRC_INFO | (trace current program/include/source |
| | line) |
| ADD_EVENT_INFO | (trace current events -> for event |
| | tree) |
| ADD_CUSTOM_INFO | (trace your info -> structure |
| | TPDA_TRACE_CUSTOM) |
| ADD_CUSTOM_TREE_INFO | (trace your tree like info -> structure |
| | TPDA_TRACE_CUSTOM_TREE) |

An example of this service is:

Event trace:

```
      method script.
*** insert your script code here
*** example: trace source info
    trace->add_event_info( ).
endmethod.
```

A further service is “data description”: This service is similar to runtime type information (RTTI) that provide description objects for ABAP data structures. For each ABAP data type there is one dedicated description class:

CL_TPDA_SCRIPT_..._DESCR. They all inherit from
CL_TPDA_SCRIPT_DATADESCR.

In order to get a description object for a variable, use method factory of CL_TPDA_SCRIPT_DATADESCR:

Data l_itab_descr type ref to cl_tpda_script_tabledescr
l_itab_descr ?= cl_tpda_script_data_descr=>factory( p_itab_name ).
l_components = l_itab_descr->components( ).
l_content_it = l_itab_descr->content( ).

With a service “source code info” regarding, for example, a current program and stack, the debugger script may use the same technique as for ABAP variables:
CL_TPDA_SCRIPT_SRC_DESCR→factory returns a description object (e.g. CL_TPDA_SCRIPT_BSPDESCR for a BSP page or CL_TPDA_SCRIPT_STDESCR for simple transformation or CL_TPDA_SCRIPT_ABAPDESCR for ABAP or Dynpro)

For quick access if you know that you are in the ABAP environment you may use the static methods: (class CL_TPDA_SCRIPT_ABAPDESCR)

GET_ABAP_STACK
GET_DYNP_STACK
GET_ABAP_DYNP_STACK
GET_UNBUFFERED_SRC_INFO
GET_UNBUFFERED_PROGRAM

For example, a script to stop when a certain program (attribute program) is reached:

method script.
*** insert your script code here

```
  try.
      if program = cl_tpda_script_abapdescr=
>get_unbuffered_program( ).
        me->break( ).
      endif.
    catch cx_tpda_src_info.
    “*** error handling
  endtry.
endmethod.
```

Various implementations of the subject matter described herein may be realized in digital electronic circuitry, integrated circuitry, specially designed ASICs (application specific integrated circuits), computer hardware, firmware, software, and/or combinations thereof. These various implementations may include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and may be implemented in a high-level procedural and/or object-oriented programming language, and/or in assembly/machine language. As used herein, the term “machine-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the subject matter described herein may be implemented on a computer having a display device (e.g., a CRT (cathode ray tube) or LCD (liquid crystal display) monitor) for displaying information to the user and a keyboard and a pointing device (e.g., a mouse or a trackball) by which the user may provide input to the computer. Other kinds of devices may be used to provide for interaction with a user as well; for example, feedback provided to the user may be any form of sensory feedback (e.g., visual feedback, auditory feedback, or tactile feedback); and input from the user may be received in any form, including acoustic, speech, or tactile input.

The subject matter described herein may be implemented in a computing system that includes a back-end component (e.g., as a data server), or that includes a middleware component (e.g., an application server), or that includes a front-end component (e.g., a client computer having a graphical user interface or a Web browser through which a user may interact with an implementation of the subject matter described herein), or any combination of such back-end, middleware, or front-end components. The components of the system may be interconnected by any form or medium of digital data communication (e.g., a communication network). Examples of communication networks include a local area network (“LAN”), a wide area network (“WAN”), and the Internet.

The computing system may include clients and servers. A client and server are generally remote from each other and typically interact through a communication network. The relationship of client and server arises by virtue of computer programs running on the respective computers and having a client-server relationship to each other.

Although a few variations have been described in detail above, other modifications are possible. For example, the logic flow depicted in the accompanying figures and described herein do not require the particular order shown, or sequential order, to achieve desirable results. Other embodiments may be within the scope of the following claims.

What is claimed is:

1. A computer-implemented method comprising:
defining a debugging script;
defining at least one trigger point and associating the at least one trigger point with the debugging script;
compiling the debugging script on the fly;
identifying a defined trigger point in a section of code during run time of a debuggee; and
executing the debugger script in response to the identification of the defined trigger to automatically debug the code.

2. A method as in claim 1, wherein the defining a debugging script comprises: generating a new debugging script.

3. A method as in claim 1, wherein the defining a debugging script comprises: modifying a pre-defined debugging script.

4. A method as in claim 3, wherein the modifying a pre-defined debugging script comprises: launching a stand-alone editor; populating the stand-alone editor with the pre-defined debugging script; and receiving user-generated input to modify the pre-defined debugging script.

5. A method as in claim 3, wherein the modifying a pre-defined debugging script comprises: accessing an integrated editor during debugging; populating the integrated editor with the pre-defined debugging script; and receiving user-generated input to modify the pre-defined debugging script.

6. A method as in claim 1, further comprising: saving the defined debugging script to a script repository.

7. A method as in claim 1, wherein the defining a trigger point comprises: creating a new trigger point.

8. A method as in claim 1, wherein the defining a debugging script comprises: modifying a pre-defined trigger point.

9. A method as in claim 8, wherein the modifying a pre-defined trigger point comprises: launching a stand-alone editor; populating the stand-alone editor with the pre-defined trigger point; and receiving user-generated input to modify the pre-defined trigger point.

10. A method as in claim 8, wherein the modifying a pre-defined trigger point comprises: accessing an integrated editor during debugging; populating the stand-alone editor with the pre-defined trigger point; and receiving user-generated input to modify the pre-defined trigger point.

11. A method as in claim 1, wherein the defining a trigger point comprises: associating a trigger point with a debugger script or an existing combination of a debugger script with a pre-defined trigger point.

12. A method as in claim 1, wherein the code is in Advanced Business Application Programming language.

13. A method as in claim 1, wherein the debugger script is in Advanced Business Application Programming language.

14. A method as in claim 1, wherein the trigger point is based on a user-defined watchpoint.

15. A method as in claim 1, wherein the trigger point is based on a user-defined breakpoint.

16. A method as in claim 1, wherein the trigger point is the current position of the code of the debuggee.

17. A method as in claim 16, wherein reaching the trigger point causes an immediate execution of the debugging script.

18. A method as in claim 1, wherein the code contains a trigger point after each step traversed by a debugger.

19. A computer-implemented method comprising:
defining one or more trigger points in a section of code to be debugged;
associating the trigger points with a debugger script or with a combination of debugger script and additional trigger points;
creating a debugger and executing the debugger script in response to identifying the defined trigger points during run time of a debuggee to automatically debug the code.

20. A computer-implemented method comprising:
identifying a trigger point within a section of code to be debugged;
launching a debugger script editor;
compile a debugger script generated on the fly in the script editor; and
executing the compiled debugger script to debug the code.
